(19) United States
(12) Patent Application Publication
(10) Pub. No.: US 2014/0103191 A1
(43) Pub. Date: Apr. 17, 2014

(54) SENSING METHODS FOR IMAGE SENSORS

(71) Applicant: Samsung Electronics Co., Ltd., Suwon-Si (KR)

(72) Inventors: Ju Hwan JUNG, Seoul (KR); Dong Ki MIN, Seoul (KR); Young Gu JIN, Osan-si (KR); Seok Yong HONG, Seoul (KR)

(73) Assignee: SAMSUNG ELECTRONICS CO., LTD., Suwon-Si (KR)

(21) Appl. No.: 14/030,180

(22) Filed: Sep. 18, 2013

Related U.S. Application Data
(60) Provisional application No. 61/713,175, filed on Oct. 12, 2012.

(30) Foreign Application Priority Data
Feb. 13, 2013 (KR) 10-2013-0015344

(51) Int. Cl. H04N 5/378

(52) U.S. Cl. CPC H04N 5/378
USPC 250/208.1

(57) ABSTRACT

A sensing method for an image sensor includes: connecting a first column line with a second column line in response to switch signals; and sensing a first pixel signal generated based on a first signal output from a first pixel and a second signal output from a second pixel, the first pixel and the second pixel being connected to the first column line and the second pixel being connected to the second column line.

### CROSS-REFERENCE TO RELATED APPLICATIONS

This application claims priority under 35 U.S.C. §119(e) to U.S. provisional patent application No. 61/713,175 filed on Oct. 12, 2012, and under 35 U.S.C. §119(a) to Korean Patent Application No. 10-2013-0015344 filed on Feb. 13, 2013, the entire contents of each of which are hereby incorporated by reference.

### BACKGROUND

1. Field

Example embodiments of inventive concepts relate to image sensors, and more particularly, to sensing methods for image sensors including pixels having a single transistor structure.

2. Description of Conventional Art

An image sensor is a device that converts optical image signals into electrical signals. The image sensor includes a plurality of pixels. When each of the pixels includes a transfer transistor, a reset transistor, a selection transistor, and a source follower transistor, each of the pixels is referred to as a 4T pixel.

With the development of technology, the size of a pixel has decreased. Instead of a 4T pixel, a pixel having a single transistor structure has been developed. However, a detailed sensing method for image sensors including pixels with single transistor structures is not known.

### SUMMARY

At least one example embodiment provides a sensing method for an image sensor including a plurality of pixels, wherein each of the plurality of pixels is connected to one of a plurality of row lines and one of a plurality of column lines. The sensing method includes: connecting a first of the plurality of column lines with a second of the plurality of column lines in response to switch signals; and sensing a first pixel signal generated based on a first signal output from a first pixel and a second signal output from a second pixel, the first pixel being connected to the first column line and the second pixel being connected to the second column line.

According to at least some example embodiments, the method may further include: applying a first voltage signal to the plurality of row lines to integrate photoelectrons in all remaining pixels excluding pixels connected to the first and second column lines. The pixels connected to the first column line or the second column line may be shielded by a metal.

According to at least some example embodiments, the method may further include: applying a first column voltage signal to the first column line to generate the first signal; and applying a second column voltage signal to the second column line to generate the second signal. The first column voltage signal and the second column voltage signal may have different voltage levels.

According to at least some example embodiments, the method may further include: applying a first voltage signal to a row line connected to the first pixel and the second pixel to output the first signal and the second signal.

According to at least some example embodiments, a third of the plurality of column lines may be adjacent to one of the first and second column lines, and the method may further include: disconnecting the first column line from the second column line; connecting the third column line with the adjacent one of the first and second column lines; and sensing a second pixel signal generated based on the second signal and a third signal output from a third pixel connected to the third column line. The first pixel signal and the second pixel signal may be sensed sequentially.

At least one other example embodiment provides a sensing method for an image sensor including a plurality of odd-numbered pixels and a plurality of even-numbered pixels, wherein each of the plurality of odd-numbered pixels is connected to one of a plurality of first row lines and one of a plurality of odd-numbered column lines, and each of the plurality of even-numbered pixels is connected to one of a plurality of second row lines and one of a plurality of even-numbered column lines. In this case, the sensing method includes: connecting each odd-numbered column line with a corresponding even-numbered column line; and sensing, for each pair of connected odd-numbered column line and corresponding even-numbered column line, a pixel signal generated based on a first signal output from a first pixel connected to the odd-numbered column line and a second signal output from a second pixel connected to the corresponding even-numbered column line.

According to at least some example embodiments, the method may further include: applying a first voltage signal to the plurality of second row lines to integrate photoelectrons in the plurality of even-numbered pixels.

According to at least some example embodiments, the method may further include: applying a second voltage signal to the plurality of first row lines to prevent photoelectrons from being integrated in the plurality of odd-numbered pixels.

According to at least some example embodiments, for each pair of connected odd-numbered column line and corresponding even-numbered column line the method may further include: applying a first column voltage signal to the odd-numbered column line to generate the first signal; and applying a second column voltage signal to the corresponding even-numbered column line to generate the second signal. The first column voltage signal and the second column voltage signal may have different voltage levels.

According to at least some example embodiments, the method may further include: applying a first voltage signal to a row line connected with the first and second pixels to output the first signal and the second signal.

According to at least some example embodiments, the pixel signals may be sensed concurrently and/or simultaneously.

At least one other example embodiment provides a sensing method for an image sensor, the method including: sensing, at a sensing circuit, a first pixel signal generated based on a first signal output from a first of a plurality of pixels via a first column line and a second signal output from a second of the plurality of pixels via a second column line, the first column line and the second column line being concurrently connected to the sensing circuit in response to respective first and second switch signals.

According to at least some example embodiments, the method may further include: connecting the first column line with the second column line.

According to at least some example embodiments, a third column line may be adjacent to one of the first and second column lines, and the method may further include: disconnecting the first column line from the second column line; connecting the third column line to the adjacent one of the first and second column lines; and sensing a second pixel signal generated based on the second signal and a third signal output from a third pixel connected to the third column line.

According to at least some example embodiments, the method may further include: applying a first column voltage signal to the first column line to generate the first signal; and applying a second column voltage signal to the second column line to generate the second signal. The first column voltage signal and the second column voltage signal may have different voltage levels.

According to at least some example embodiments, the first column line may be an odd-numbered column line among a plurality of odd-numbered column lines and the second column line may be an even-numbered column line among a plurality of odd-numbered column lines.

According to at least some example embodiments, the plurality of pixels may include a plurality of odd-numbered pixels and a plurality of even-numbered pixels, wherein each of the plurality of odd-numbered pixels may be connected to one of the plurality of odd-numbered column lines, and each of the plurality of even-numbered pixels may be connected to one of the plurality of even-numbered column lines, and wherein the first pixel may be an odd-numbered pixel among the plurality of odd-numbered pixels and the second pixel may be an even-numbered pixel among the plurality of even-numbered pixels. In this case, the method may further include: connecting each odd-numbered column line with a corresponding even-numbered column line; and sensing, for each pair of connected odd-numbered column line and corresponding even-numbered column line, a pixel signal generated based on a first signal output from an odd-numbered pixel connected to the odd-numbered column line and a second signal output from an even-numbered pixel connected to the corresponding even-numbered column line. The pixel signals for each pair of connected odd-numbered column line and corresponding even-numbered column line may be sensed concurrently and/or simultaneously.

### BRIEF DESCRIPTION OF THE DRAWINGS

The above and other features and advantages of inventive concepts will become more apparent by describing in detail example embodiments thereof with reference to the attached drawings in which:

FIG. 1 is a block diagram of an image processing system according to some example embodiments of inventive concepts;

FIGS. 2 through 6 are block diagrams of a pixel array provided to explain an example embodiment of a sensing method for the image sensor illustrated in FIG. 1;

FIG. 7 is a block diagram of an equivalent circuit provided to explain an example embodiment of a sensing method of the image sensor illustrated in FIG. 1;

FIGS. 8 through 11 are block diagrams of a pixel array provided to explain other example embodiments of sensing methods for the image sensor illustrated in FIG. 1;

FIG. 12 is a flowchart illustrating example embodiments of sensing methods illustrated in FIGS. 2 through 6 using the image sensor illustrated in FIG. 1;

FIG. 13 is a flowchart illustrating example embodiments of the sensing methods illustrated in FIGS. 8 through 11 using the image sensor illustrated in FIG. 1;

FIG. 14 is a cross-sectional view of an example of a pixel illustrated in FIG. 2;

FIG. 15 is a cross-sectional view of another example of the pixel illustrated in FIG. 2;

FIG. 16 is a block diagram of an image processing system including the image sensor illustrated in FIG. 1 according to other example embodiments of inventive concepts; and

FIG. 17 is a block diagram of an image processing system including the image sensor illustrated in FIG. 1 according to other example embodiments of inventive concepts.

### DETAILED DESCRIPTION

Inventive concepts now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity. Like numbers refer to like elements throughout.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. As used herein, the term “and/or” includes any and all combinations of one or more of the associated listed items and may be abbreviated as “/”.

It will be understood that, although the terms first, second, etc. may be used herein to describe various elements, these elements should not be limited by these terms. These terms are only used to distinguish one element from another. For example, a first signal could be termed a second signal, and, similarly, a second signal could be termed a first signal without departing from the teachings of the disclosure.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and/or the present application, and will not be interpreted in an idealized or overly formal sense unless expressly so defined herein.

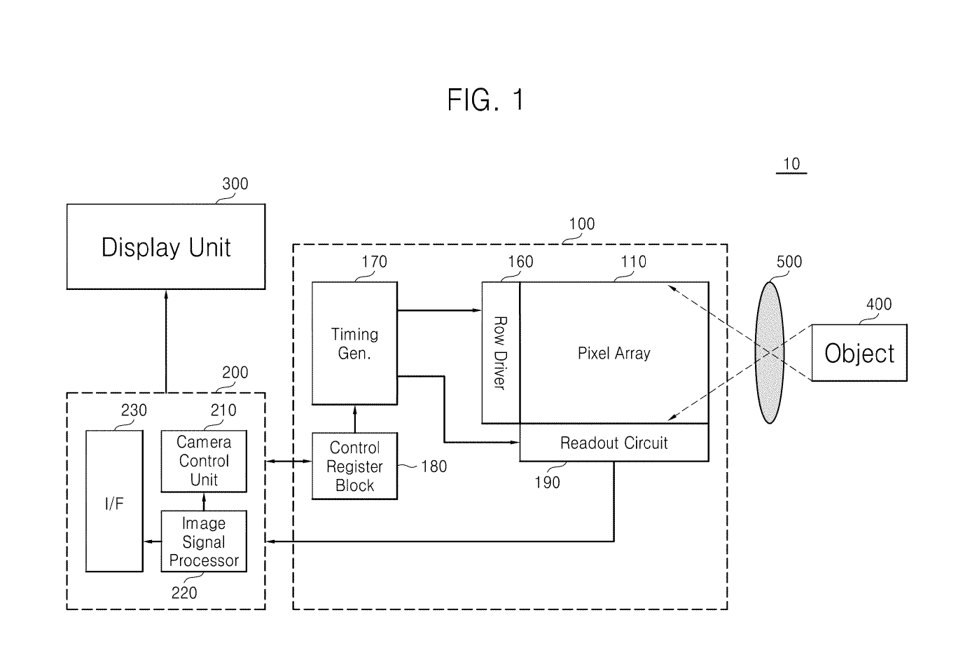

FIG. 1 is a block diagram of an image processing system 10 according to some example embodiments of inventive concepts.

The image processing system 10 may include an image sensor 100, a digital signal processor (DSP) 200, a display unit 300, and a lens 500. The image sensor 100 may include a pixel array 110, a row driver 160, a timing generator 170, a control register block 180, and a readout circuit 190.

The image sensor 100 may be controlled by the DSP 200 to sense an object 400 captured through the lens 500. The DSP 200 may output an image, which has been sensed and output by the image sensor 100, to the display unit 300. At this time, the display unit 300 may be any device that can output an image. For instance, the display unit 300 may be implemented as a computer, a mobile phone, or any other image output terminal.

The DSP 200 may include a camera control unit 210, an image signal processor (ISP) 220, and an interface (I/F) 230. The camera control unit 210 controls the control register block 180. The camera control unit 210 may control the image sensor 100, and more specifically, the control register block 180 using an inter-integrated circuit (I²C), but the scope of inventive concepts is not restricted thereto.

The ISP 220 processes a pixel signal output from the readout circuit 190 into an image nice for people to look at and outputs the image to the display unit 300 through the I/F 230. The ISP 220 is implemented in a chip separated from the image sensor 100. In other embodiments, the ISP 220 and the image sensor 100 may be integrated into a single chip.

The pixel array 110 may include a plurality of unit pixels. Each unit pixel includes a single transistor and a photoelectric conversion element, such as a photo diode or a pinned photo diode.

Each unit pixel may include only single transistor so as to increase the degree of integration of the image sensor 100. For instance, the image sensor 100 may include unit pixels having a size of 0.1×0.1 μm or less. The pixel array 110 senses light using a plurality of photoelectric conversion elements and converts the light into an electrical signal, thereby generating an image signal.

The timing generator 170 may output a control signal or a clock signal to the row driver 160 and the readout circuit 190 to control the operations or the timing of the row driver 160 and the readout circuit 190. The control register block 180 is controlled by the camera control unit 210 and stores various commands necessary for the operation of the image sensor 100.

The row driver 160 drives the pixel array 110 in row units. The row driver 160 may provide a voltage signal for the single transistor of each unit pixel in the pixel array 110. In other words, the row driver 160 may decode a control signal from the timing generator 170 and provide a gate voltage signal for each of rows in the pixel array 110.

The pixel array 110 outputs a pixel signal from a row selected by the gate voltage signal, which is provided from the row driver 160, to the readout circuit 190. The readout circuit 190 reads and outputs the pixel signal from the pixel array 110 to the DSP 200.

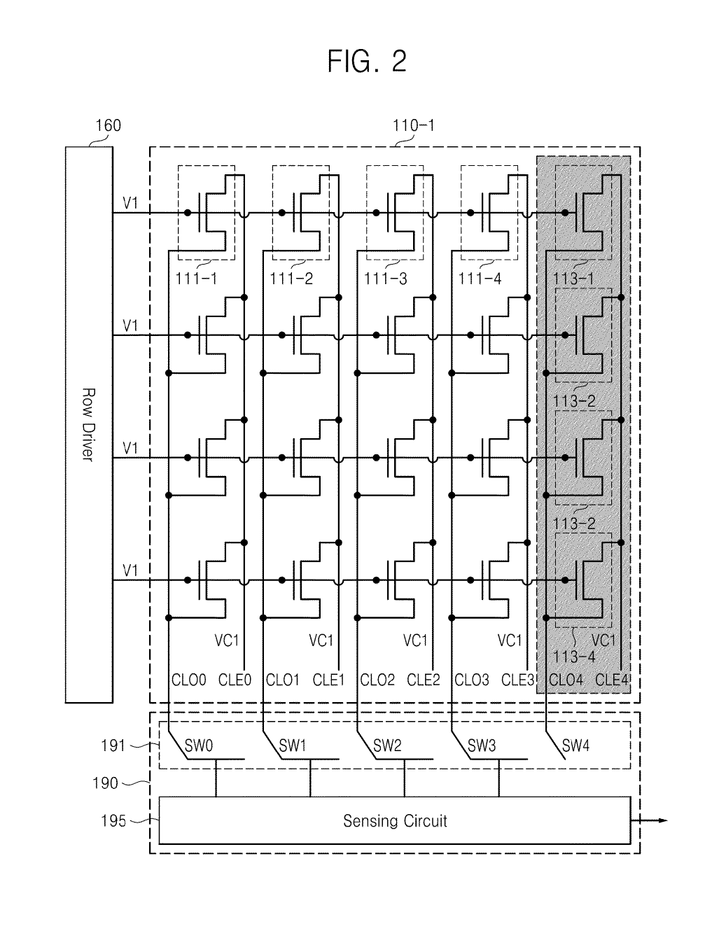

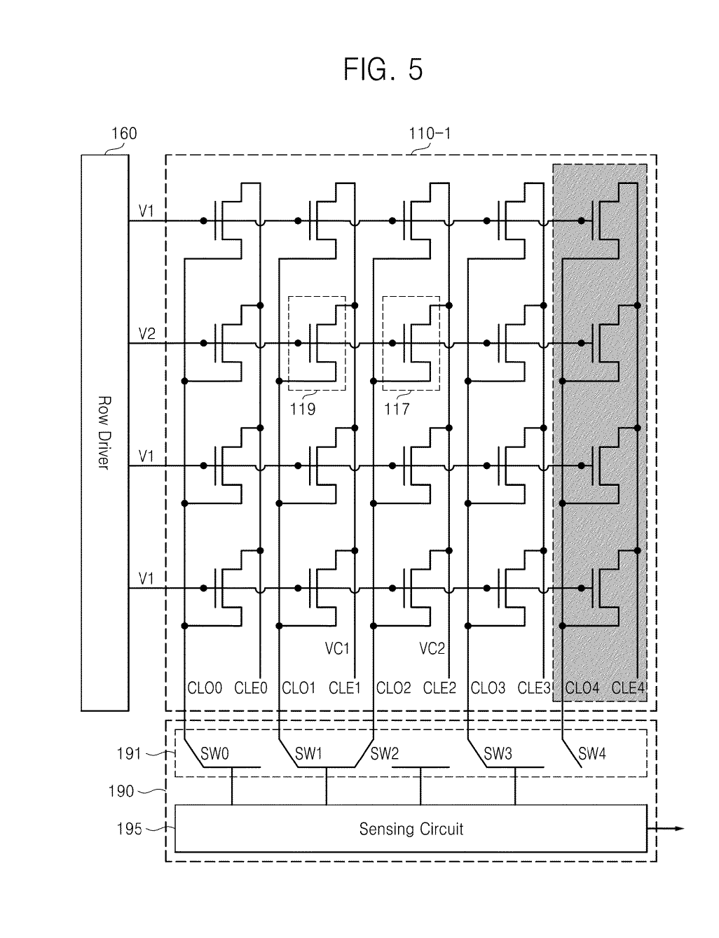

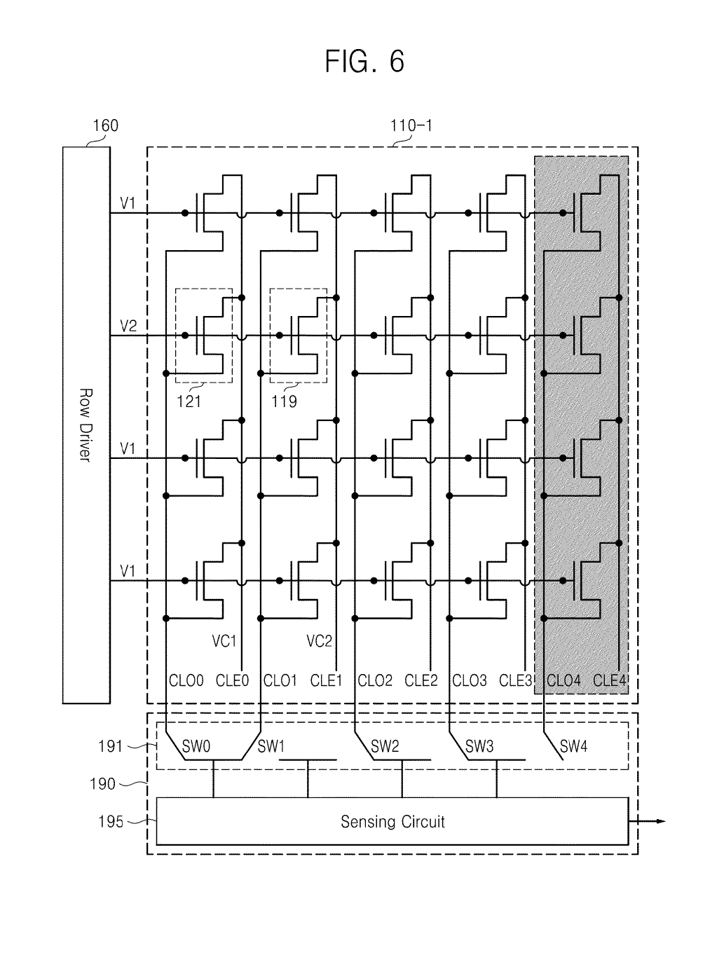

FIGS. 2 through 6 are block diagrams of a pixel array 110-1 provided to explain example embodiments of sensing methods for the image sensor 100 illustrated in FIG. 1. The pixel array 110-1 illustrated in FIGS. 2 through 6 is an example of the pixel array 110 illustrated in FIG. 1.

Referring to FIGS. 1 and 2, the pixel array 110-1 includes a plurality of pixels 111-1 through 111-4 and 113-1 through 113-4. Although a 5×4 pixel matrix is illustrated in FIG. 2, the form of a pixel matrix may vary.

The pixels 111-1 through 111-4 and 113-1 through 113-4 are connected to row lines and column lines. A gate terminal of a transistor in the pixels 111-1 through 111-4 and 113-1 through 113-4 is connected to a row line, a source terminal of the transistor is connected to one of column lines CLE0 through CLE4, and a drain terminal of the transistor is connected to one of column lines CLO0 through CLO4.

The pixels 111-1 through 111-4 and 113-1 through 113-4 may be divided into reference pixels 113-1 through 113-4 and active pixels 111-1 through 111-4. The reference pixels 113-1 through 113-4 are shielded by a metal.

Accordingly, the reference pixels 113-1 through 113-4 cannot integrate photoelectrons. In other words, the reference pixels 113-1 through 113-4 do not perform an integration operation in which a photo diode generates and integrates photoelectrons. The reference pixels 113-1 through 113-4 are marked with a shade of grey in FIG. 2.

The active pixels 111-1 to 111-4 perform the integration operation in which a photo diode generates and integrates photoelectrons. In order to allow the active pixels 111-1 to 111-4 to perform the integration operation, the row driver 160 applies a first voltage signal V1 to the row lines. The first voltage signal V1 may be 0 V.

In addition, the timing generator 170 applies a first column voltage signal VC1 to the column lines CLE0 through CLE4. The first column voltage signal VC1 may be 0 V.

The readout circuit 190 includes a switch circuit 191 and a sensing circuit 195. The switch circuit 191 and the sensing circuit 195 will be described in detail later.

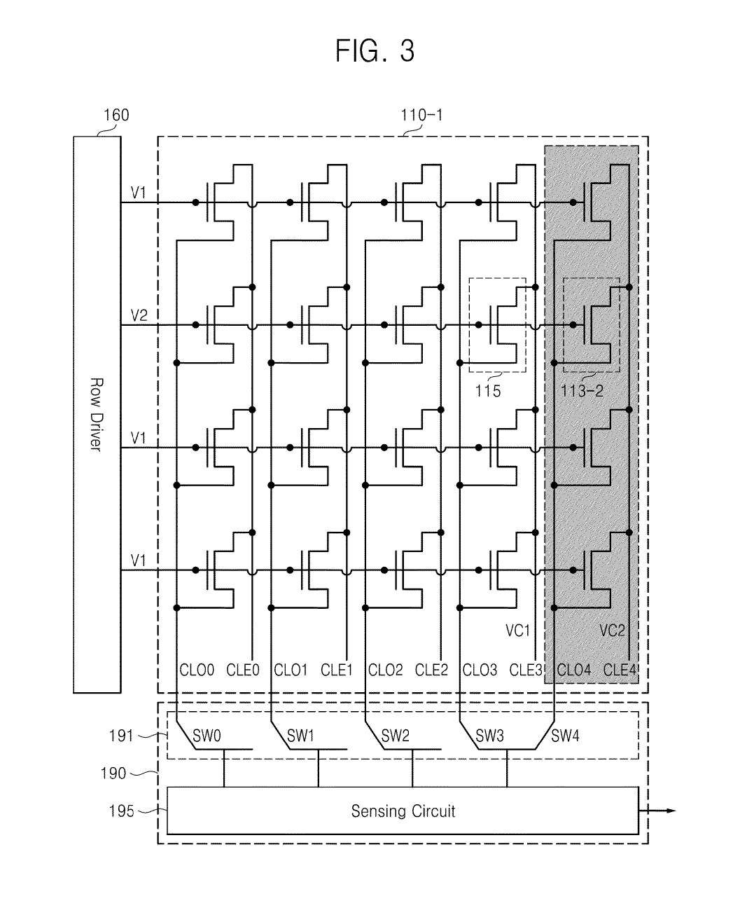

Referring to FIGS. 1 and 3, after the integration operation is performed, a signal corresponding to the photoelectrons integrated at the photo diode is output through a column line in a readout operation.

In order to allow an active pixel 115 and the reference pixel 113-2 to output signals, the row driver 160 applies a second voltage signal V2 to a row line to which the active pixel 115 and the reference pixel 113-2 are connected. The row driver 160 applies the first voltage signal V1 to all of the other row lines. The first voltage signal V1 is 0 V and the second voltage signal V2 is −3 V.

In addition, to allow the active pixel 115 and the reference pixel 113-2 to output signals, the timing generator 170 applies the first column voltage signal VC1 and a second column voltage signal VC2 to the column lines CLE3 and CLE4, respectively. The first column voltage signal VC1 may be a ground voltage and the second column voltage signal VC2 may be a power supply voltage.

The switch circuit 191 connects the two column lines CLO3 and CLO4 with each other among the column lines CLO0 through CLO4 in response to switch signals SW0 through SW4 output from the timing generator 170.

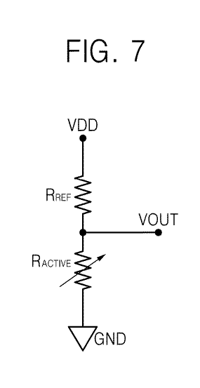

FIG. 7 is a block diagram of an equivalent circuit provided to explain an example embodiment of the sensing method for the image sensor illustrated in FIG. 1.

Referring to FIGS. 1, 3, and 7, the pixels 115 and 113-1 may be represented as the equivalent circuit illustrated in FIG. 7 according to signals applied to the pixels 115 and 113-2.

The source terminal of a transistor in the reference pixel 113-2 corresponds to a power supply terminal VDD and the drain terminal of the transistor corresponds to an output terminal VOUT.

The source terminal of a transistor in the active pixel 115 corresponds to a ground terminal GND and the drain terminal of the transistor corresponds to the output terminal VOUT. Since the column lines CLO3 and CLO4 are connected with each other by the switch circuit 191, the reference pixel 113-2 and the active pixel 115 share the output terminal VOUT with each other.

A signal output from the reference pixel 113-2 may be a voltage or current signal generated based on a reference resistance R_{REF}. A signal output from the active pixel 115 may be a voltage or current signal generated based on an active resistance R_{ACTIVE}. The active resistance R_{ACTIVE} is a variable resistance that varies with the number of photoelectrons integrated at a photo diode.

The sensing circuit 195 senses pixel signals according to the signals (e.g., the voltage signals or current signals) respectively output from the active pixel 115 and the reference pixel 113-2 and outputs the pixel signal to the DSP 200.

The pixel signal (e.g., a voltage or current signal) at the output terminal VOUT is determined depending on the reference resistance R_{REF} and the active resistance R_{ACTIVE}. In other words, when the first column voltage signal VC1 and the second column voltage signal VC2 are respectively applied to the column lines CLE3 and CLE4, an output voltage at the output terminal VOUT shared by the active pixel 115 and the reference pixel 113-2 corresponds to a resistance variation of the active pixel 115.

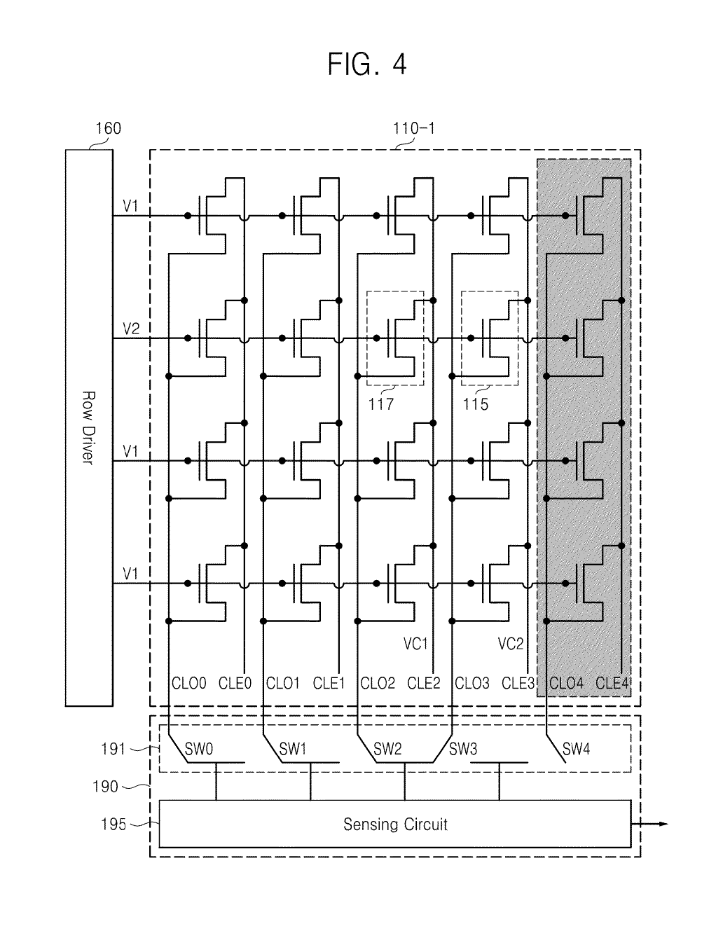

Referring to FIGS. 1 and 4, in order to perform a readout operation on an active pixel 117 after the readout operation on the active pixel 115, similarly, the switch circuit 191 disconnects the column lines CLO3 and CLO4 from each other and connects the column lines CLO2 and CLO3 with each other in response to the switch signals SW0 through SW4 output from the timing generator 170.

The row driver 160 applies the second voltage signal V2 to a row line to which the active pixels 115 and 117 are connected. The row driver 160 applies the first voltage signal V1 to all of the other row lines. The timing generator 170 applies the first column voltage signal VC1 and the second column voltage signal VC2 to the column lines CLE2 and CLE3, respectively. The first column voltage signal VC1 may be the ground voltage and the second column voltage signal VC2 may be the power supply voltage.

Referring to FIGS. 4 and 7, the pixels 115 and 117 may be represented as the equivalent circuit illustrated in FIG. 7 according to signals applied to the pixels 115 and 117.

The source terminal of the transistor in the active pixel 115 corresponds to the power supply terminal VDD and the drain terminal of the transistor corresponds to the output terminal VOUT.

The source terminal of a transistor in the active pixel 117 corresponds to the ground terminal GND and the drain terminal of the transistor corresponds to the output terminal VOUT. A signal output from the active pixel 115 may be a voltage or current signal generated based on the reference resistance R_{REF}. A signal output from the active pixel 117 may be a voltage or current signal generated based on the active resistance R_{ACTIVE}.

The sensing circuit 195 senses pixel signals according to the signals (e.g., the voltage signals or current signals) respectively output from the active pixels 115 and 117 and outputs the pixel signals to the DSP 200.

Referring to FIGS. 1, 5, and 6, similarly, the switch circuit 191 connects the column lines CLO1 and CLO2 with each other and then connects the column lines CLO0 and CLO1 with each other in response to the switch signals SW0 through SW4 output from the timing generator 170.

The row driver 160 applies the second voltage signal V2 to a row line to which active pixels 117 and 119, or 119 and 121 are connected. The row driver 160 applies the first voltage signal V1 to all of the other row lines. The timing generator 170 sequentially and alternately applies the column voltage signals VC1 and VC2 to the column lines CLE2, CLE1, and CLE0. The first column voltage signal VC1 may be the ground voltage and the second column voltage signal VC2 may be the power supply voltage.

The sensing circuit 195 sequentially senses and outputs pixel signals to the DSP 200 according to the signals output from the active pixels 117, 119, and 121.

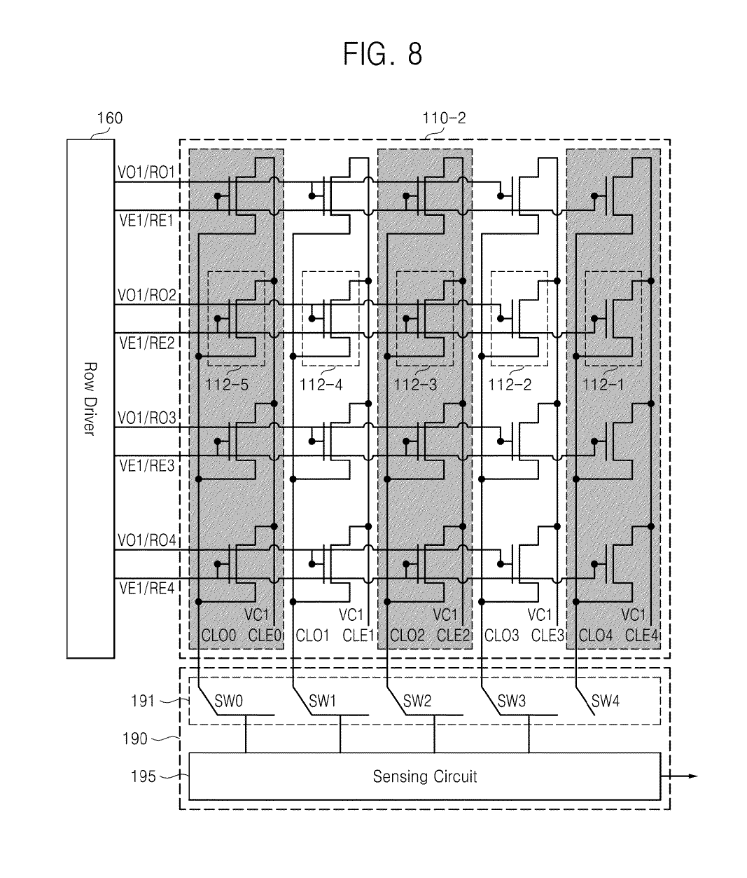

FIGS. 8 through 11 are block diagrams of a pixel array 110-2 provided to explain a sensing method of the image sensor 100 illustrated in FIG. 1 according to other embodiments of inventive concepts. The pixel array 110-2 illustrated in FIGS. 8 through 11 is another example of the pixel array 100 illustrated in FIG. 1.

Referring to FIGS. 1 and 8, the pixel array 110-2 includes a plurality of pixels 112-1 through 112-5. As described with reference to FIG. 2, although a 5×4 pixel matrix is illustrated in FIG. 8, the form of a pixel matrix may vary.

A gate terminal of a transistor in odd-numbered pixels (e.g., 112-1, 112-3, and 112-5) is connected to one of first row lines RE1 through RE4. A gate terminal of a transistor in even-numbered pixels (e.g., 112-2 and 112-4) is connected to one of second row lines RO1 through RO4. A source terminal of the transistor in the pixels 112-1 through 112-5 is connected to one of the column lines CLE0 through CLE4 and a drain terminal of the transistor is connected to one of the column lines CLO0 through CLO4.

The even-numbered pixels (e.g., 112-2 and 112-4) perform the integration operation in which a photo diode generates and integrates photoelectrons. In order to allow the even-numbered pixels (e.g., 112-2 and 112-4) to perform the integration operation, the row driver 160 applies a first voltage signal VO1 to the second row lines RO1 through RO4. The first voltage signal VO1 may be 0 V.

In order to prevent the integration operation from being performed in the odd-numbered pixels (e.g., 112-1, 112-3, and 112-5), the row driver 160 applies a second voltage signal VE1 to the first row lines RE1 through RE4. The second voltage signal VE1 may be −2 V. The odd-numbered pixels (e.g., 112-1, 112-3, and 112-5) are marked with a shade of grey in FIG. 8.

The timing generator 170 applies the first column voltage signal VC1 to the column lines CLE0 through CLE4. The first column voltage signal VC1 may be 0 V. Accordingly, in the pixel array 110-2, while the even-numbered pixels (e.g., 112-2 and 112-4) perform the integration operation, the odd-numbered pixels (e.g., 112-1, 112-3, and 112-5) do not perform the integration operation.

The readout circuit 190 includes the switch circuit 191 and the sensing circuit 195. The switch circuit 191 and the sensing circuit 195 will be described in detail later.

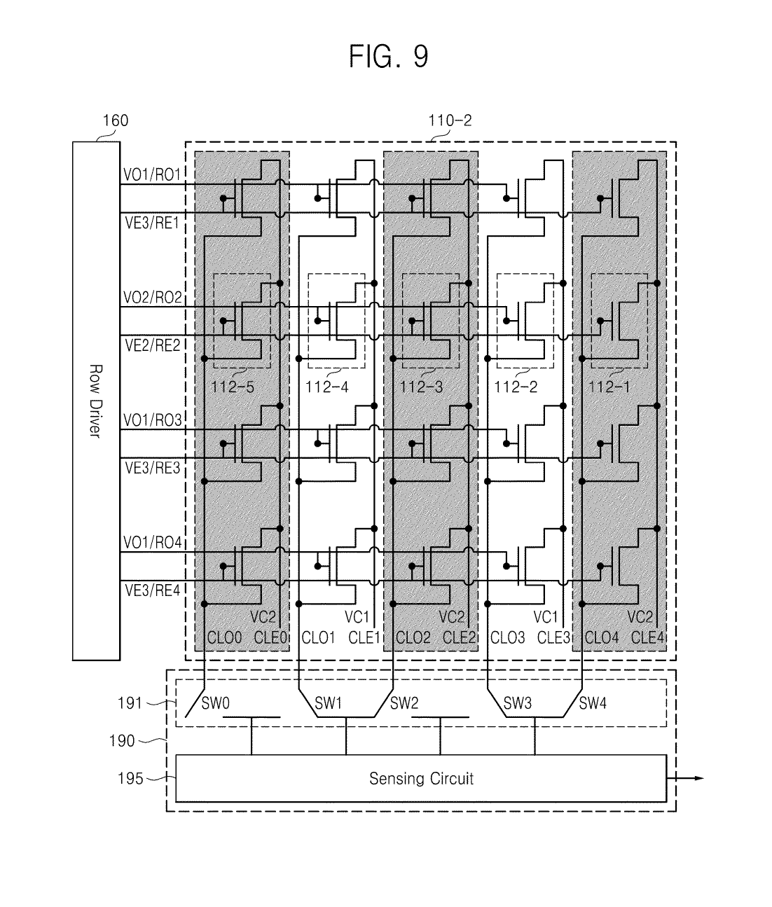

Referring to FIGS. 1 and 9, after the integration operation on the even-numbered pixels (e.g., 112-2 and 112-4), a signal corresponding to the photoelectrons integrated at the photo diode is output through a column line in a readout operation.

In order to allow the pixels 112-1 and 112-2 or 112-3 and 112-4 to output signals, the row driver 160 applies voltage signals VO2 and VE2 to the row lines RO2 and RE2, respectively, to which the pixels 112-2 and 112-1 or 112-4 and 112-3 are respectively connected. The row driver 160 applies a voltage signal VO1 to all of the other second row lines RO1, RO3, and RO4 and a voltage signal VE3 to all of the other first row lines RE1, RE3, and RE4. The voltage signals VO2 and VE2 are −3 V and the voltage signals VO1 and VE3 are 0 V.

The timing generator 170 applies the first column voltage signal VC1 to the column lines CLE1 and CLE3 and the second column voltage signal VC2 to the column lines CLE0, CLE2, and CLE4. The first column voltage signal VC1 may be the ground voltage and the second column voltage signal VC2 may be the power supply voltage.

The switch circuit 191 connects two column lines CLO1 and CLO2 with each other and two column lines CLO3 and CLO4 with each other in response to the switch signals SW0 through SW4 output from the timing generator 170.

The sensing circuit 195 senses pixel signals according to signals respectively output from the pixels 112-1 through 112-5 and outputs the pixel signals to the DSP 200. In other words, when the first column voltage signal VC1 and the second column voltage signal VC2 are respectively applied to the column lines CLE3 and CLE4, an output voltage at the output terminal VOUT shared by the even-numbered pixel 112-2 functioning as an active pixel and the odd-numbered pixel 112-1 functioning as a reference pixel corresponds to a resistance variation of the even-numbered pixel 112-2. The pixel signals are sensed simultaneously.

Referring to FIGS. 7 and 9, the pixels 112-1 and 112-2 may be represented as the equivalent circuit illustrated in FIG. 7 according to signals applied to the pixels 112-1 and 112-2.

The source terminal of a transistor in the pixel 112-1 corresponds to the power supply terminal VDD and the drain terminal of the transistor corresponds to the output terminal VOUT.

The source terminal of a transistor in the pixel 112-2 corresponds to the ground terminal GND and the drain terminal of the transistor corresponds to the output terminal VOUT. A signal output from the pixel 112-1 may be a voltage or current signal generated based on the reference resistance R_{REF}. A signal output from the pixel 112-2 may be a voltage or current signal generated based on the active resistance R_{ACTIVE}.

The sensing circuit 195 simultaneously senses pixel signals according to the signals respectively output from the pixels 112-1 and 112-2 and simultaneously outputs the pixel signals to the DSP 200.

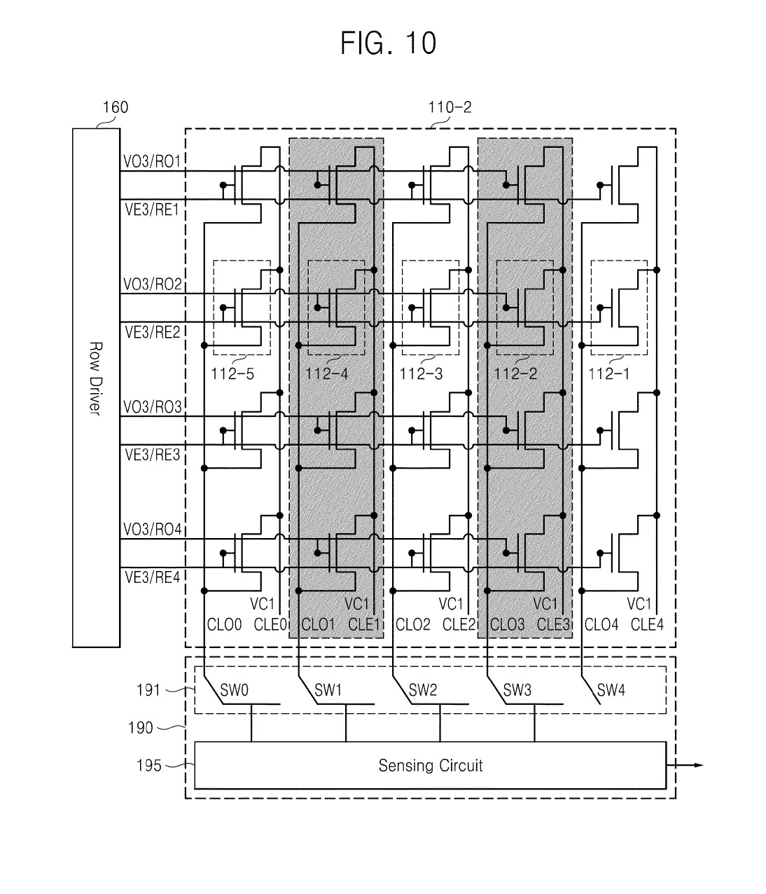

Referring to FIGS. 1 and 10, on the contrary to the state illustrated in FIG. 8, the odd-numbered pixels (e.g., 112-1, 112-3, and 112-5) perform the integration operation. In order to allow the odd-numbered pixels (e.g., 112-1, 112-3, and 112-5) to perform the integration operation, the row driver 160 applies the voltage signal VE3 to the first row lines RE1 through RE4. The voltage signal VE3 may be 0 V.

The even-numbered pixels (e.g., 112-2 and 112-4) do not perform the integration operation. In order to prevent the integration operation from being performed in the even-numbered pixels (e.g., 112-2 and 112-4), the row driver 160 applies a voltage signal VO3 to the second row lines RO1 through RO4. The voltage signal VO3 may be −2 V. The even-numbered pixels (e.g., 112-2 and 112-4) are marked with a shade of grey in FIG. 10.

The timing generator 170 applies the first column voltage signal VC1 to the column lines CLE0 through CLE4. The first column voltage signal VC1 may be 0 V. The odd-numbered pixels (e.g., 112-1, 112-3, and 112-5) and the even-numbered pixels (e.g., 112-2 and 112-4) alternately perform the integration operation.

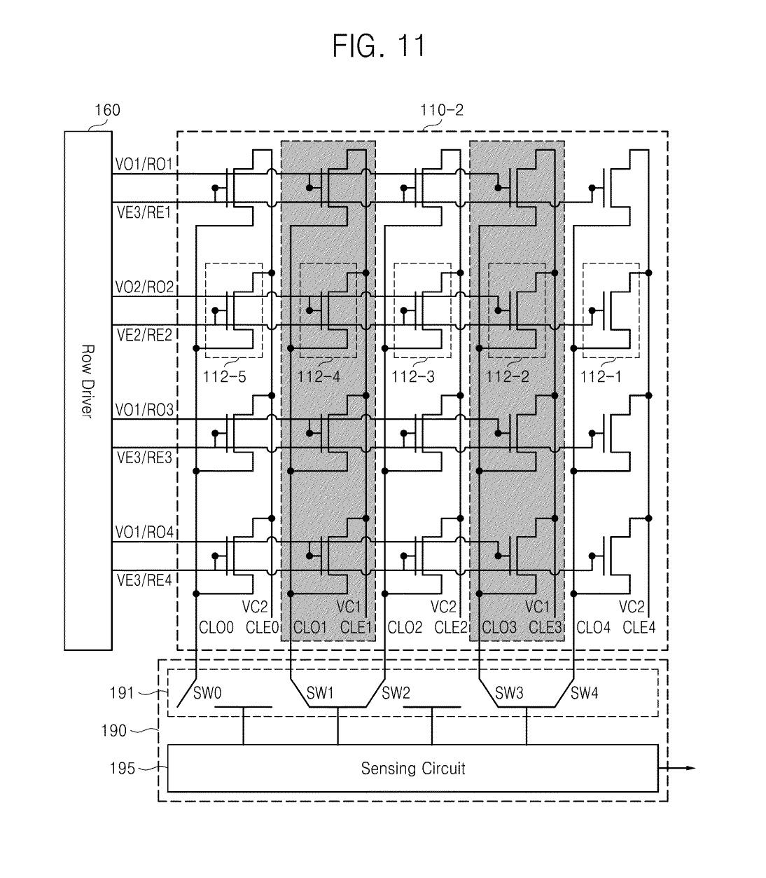

Referring to FIGS. 1 and 11, after the integration operation on the odd-numbered pixels (e.g., 112-1, 112-3, and 112-5), a signal corresponding to the photoelectrons integrated at the photo diode is output through a column line in a readout operation.

In order to allow the pixels 112-1 and 112-2 or 112-3 and 112-4 to output signals, the row driver 160 applies the voltage signals VO2 and VE2 to the row lines RO2 and RE2, respectively, to which the pixels 112-2 and 112-1 or 112-4 and 112-3 are respectively connected.

The row driver 160 applies the voltage signal VO1 to all of the other second row lines RO1, RO3, and RO4 and the voltage signal VE3 to all of the other first row lines RE1, RE3, and RE4. The voltage signals VO2 and VE2 are −3 V and the voltage signals VO1 and VE3 are 0 V.

The timing generator 170 applies the first column voltage signal VC1 to the column lines CLE1 and CLE3 and the second column voltage signal VC2 to the column lines CLE0, CLE2, and CLE4. The first column voltage signal VC1 may be the ground voltage and the second column voltage signal VC2 may be the power supply voltage.

The switch circuit 191 connects two column lines CLO1 and CLO2 with each other and two column lines CLO3 and CLO4 with each other in response to the switch signals SW0 through SW4 output from the timing generator 170.

The sensing circuit 195 senses pixel signals according to signals respectively output from the pixels 112-1 through 112-5 and outputs the pixel signals to the DSP 200.

In other words, when the first column voltage signal VC1 and the second column voltage signal VC2 are respectively applied to the column lines CLE3 and CLE4, an output voltage at the output terminal VOUT shared by the odd-numbered pixel 112-1 functioning as an active pixel and the even-numbered pixel 112-2 functioning as a reference pixel corresponds to a resistance variation of the odd-numbered pixel 112-1. The odd-numbered pixels (e.g., 112-1, 112-3, and 112-5) and the even-numbered pixels (e.g., 112-2 and 112-4) alternately perform the readout operation.

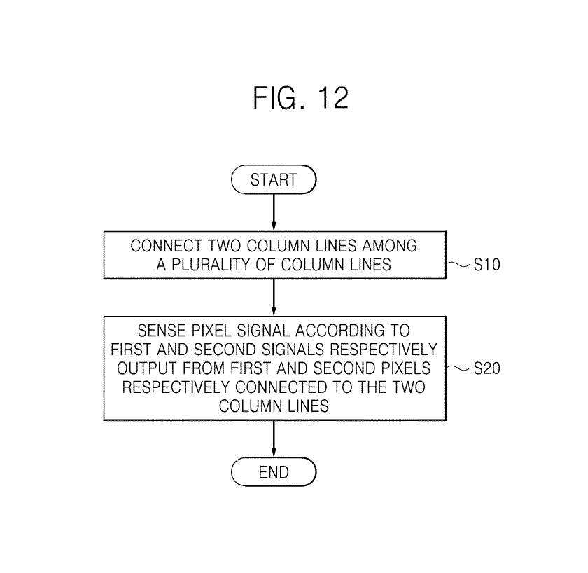

FIG. 12 is a flowchart of an example embodiment of the sensing method illustrated in FIGS. 2 through 6 using the image sensor 100 illustrated in FIG. 1.

Referring to FIGS. 1 through 7 and FIG. 12, the switch circuit 191 connects two column lines CLO3 and CLO4 among the plurality of column lines CLO0 through COL4 in response to the switch signals SW0 through SW4 output from the timing generator 170 in operation S10.

The sensing circuit 195 senses and outputs a pixel signal to the DSP 200 according to signals output from the active pixel 115 and the reference pixel 113-2 in operation S20.

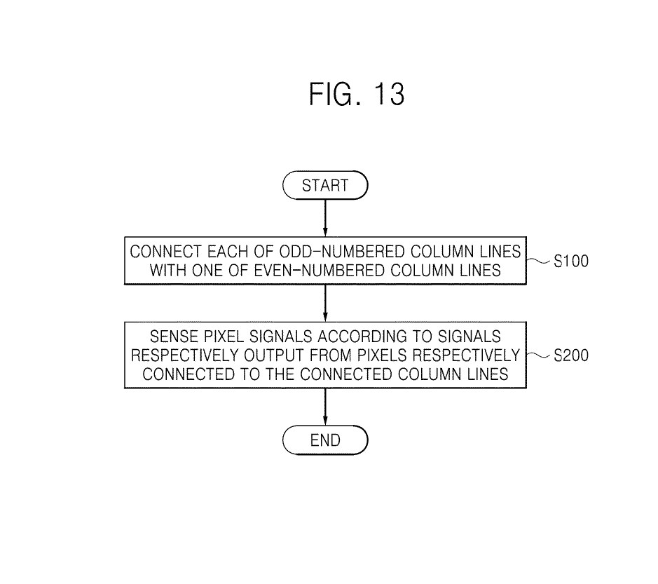

FIG. 13 is a flowchart of an example embodiment of the sensing method illustrated in FIGS. 8 through 11 using the image sensor 100 illustrated in FIG. 1.

Referring to FIGS. 1, 7 through 11, and 13, the switch circuit 191 connects each of odd-numbered column lines CLO1 and CLO3 among the plurality of column lines CLO0 through COL4 with one of even-numbered column lines COL2 and COL4 in response to the switch signals SW0 through SW4 output from the timing generator 170 in operation S100. The sensing circuit 195 senses and outputs pixel signals according to signals respectively output from the pixels 112-1 through 112-5 in operation S200.

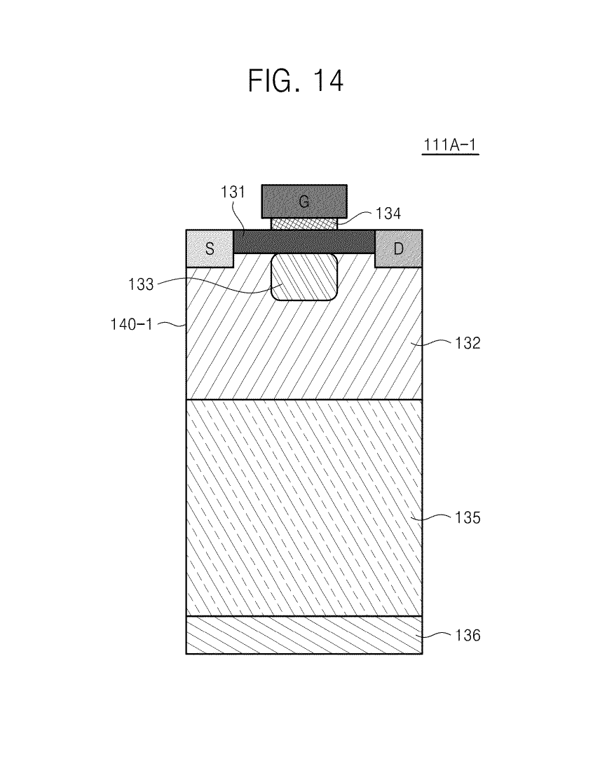

FIG. 14 is a cross-sectional view of an example 111A-1 of a pixel illustrated in FIG. 2.

Referring to FIGS. 1, 2, and 14, the pixel 111A-1 may include a source terminal S, gate terminal G and drain terminal D of a single transistor, a channel 131, a well layer 132, a photo diode 133, a gate insulating layer 134, a first epitaxial layer 135, and a second epitaxial layer 136. The semiconductor substrate 140-1 may be implemented by a silicon (Si) substrate.

The source and drain terminals S and D may be formed as a high-concentration doped region by performing ion implantation. When the single transistor is a P-channel metal oxide semiconductor (PMOS) transistor, the source terminal S and the drain terminal D may be P regions doped with P+ type impurities.

Contrarily, when the single transistor is an N-channel metal oxide semiconductor (NMOS) transistor, the source terminal S and the drain terminal D may be N regions doped with N+ type impurities. The gate terminal G may be formed of poly silicon.

The channel 131 may be formed to smooth the flow of carriers between the source terminal S and the drain terminal D of the single transistor. The carriers are holes when the single transistor is a PMOS transistor and they are electrons when the single transistor is an NMOS transistor. The channel 131 is not essential but may be selectively formed.

The well layer 132 may be doped with N− type impurities when the single transistor is a PMOS transistor and it may be doped with P− type impurities when the single transistor is an NMOS transistor.

The photo diode 133 may be formed in the well layer 132. The photo diode 133 may be doped with N type impurities when the single transistor is a PMOS transistor and with P type impurities when the single transistor is an NMOS transistor.

The gate insulating layer 134 may be formed for insulation between the gate terminal G and the channel 131. The gate insulating layer 134 may be formed of SiO₂, SiON, SiN, Al₂O₃, Si₃N₄, GeₓO_{y}N_{z}, Ge,Si_{y}O_{z}, or a high dielectric constant material. The high dielectric constant material may be formed of HfO₂, ZrO₂, Al₂O₃, Ta₂O₅, hafnium silicate, zirconium silicate, or a combination thereof.

When the single transistor is a PMOS transistor, the first and second epitaxial layers 135 and 136 may be doped with P− type and P+ type impurities, respectively. Contrarily, when the single transistor is an NMOS transistor, the first and second epitaxial layers 135 and 136 may be doped with N− type and N+ type impurities, respectively. The pixel 111A-1 may be implemented using back side illumination (BSI) which increases the light guiding efficiency of the photodiode 133.

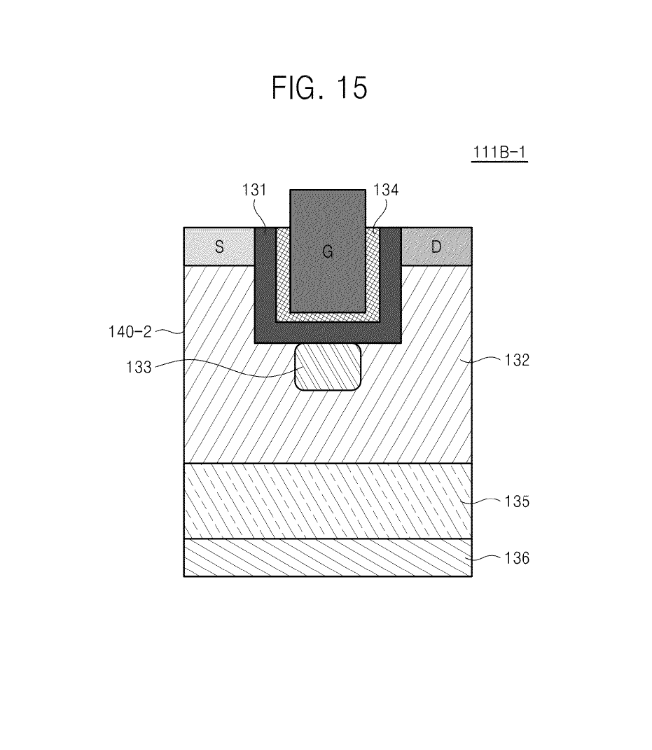

FIG. 15 is a cross-sectional view of another example 111B-1 of the pixel illustrated in FIG. 2.

Referring to FIGS. 1, 2, and 15, the gate terminal G may be embedded in a semiconductor substrate 140-2 using an etching process in the pixel 111B-1. In other words, the semiconductor substrate 140-2 may be formed in a recess gate structure. Accordingly, the channel 131 is also embedded in the semiconductor substrate 140-2 and the photodiode 133 is formed within the semiconductor substrate 140-2. Therefore, the distance from the photodiode 133 to the source terminal S or the drain terminal D increases.

When the distance between the photodiode 133 and the source terminal S or the drain terminal D increases, the influence of the photodiode 133 to the channel 131 may be increased.

In particular, when the length of the gate terminal G is 50 nm or less, the photodiode 133 is close to the source or drain terminal S or D, which obstructs the smooth operation of the single transistor.

In other words, when the length of the gate G is 50 nm or less, the distance between the photodiode 133 and the source S or the drain D becomes close, so that the influence of the photodiode 133 to the channel 131 decreases.

As a result, a pixel signal dull to photoelectrons integrated in the photodiode 133 may be generated. Therefore, when the image sensor 100 is implemented using microscopic unit pixels, it is preferable to form the pixel array 110 in the recess gate structure.

Except for the above-described differences, the semiconductor substrate 140-2 illustrated in FIG. 15 is substantially the same as the semiconductor substrate 140-1 illustrated in FIG. 14.

The operations and the functions of the photo diode 133, the well layer 132, and the first and second epitaxial layers 135 and 136 illustrated in FIG. 15 are similar to those of the photo diode 133, the well layer 132, and the first and second epitaxial layers 135 and 136 illustrated in FIG. 14. Thus, detailed descriptions thereof will be omitted.

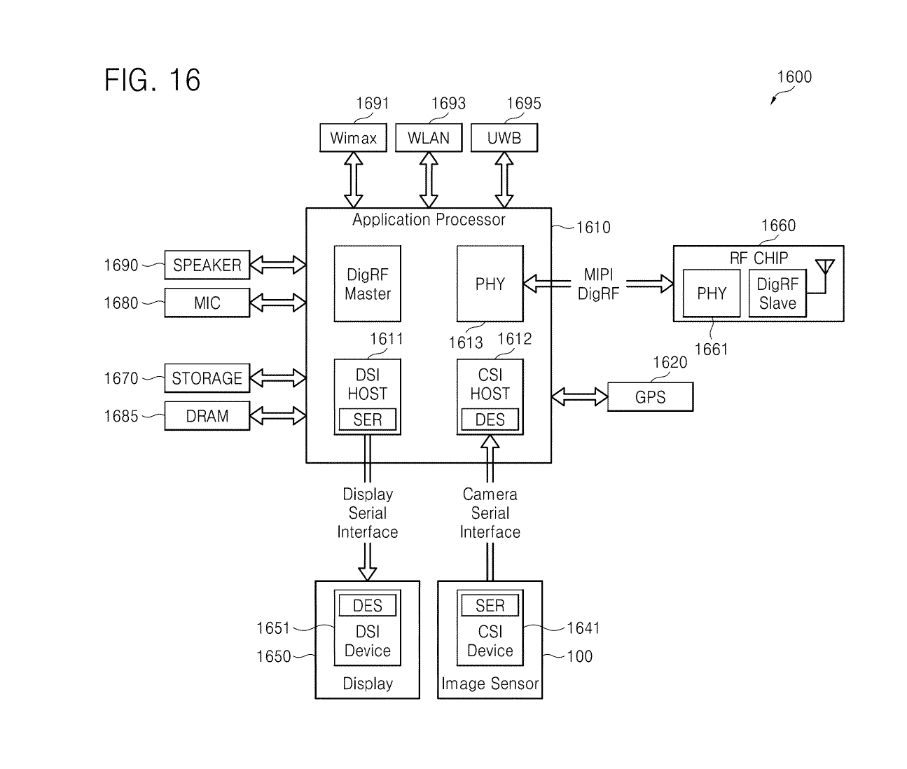

FIG. 16 is a block diagram of an image processing system 1600 including the image sensor 100 illustrated in FIG. 1 according to other embodiments of inventive concepts.

Referring to FIGS. 1 and 16, the image processing system 1600 may be implemented as a data processing device, such as a mobile phone, a personal digital assistant (PDA), a portable media player (PMP), an Internet protocol television (IPTV), or a smart phone, which can use or support mobile industry processor interface (MIPI®).

The image processing system 1600 includes the image sensor 100, an application processor 1610, and a display 1650.

A camera serial interface (CSI) host 1612 implemented in the application processor 1610 may perform serial communication with a CSI device 1641 included in the image sensor 100 through CSI. At this time, a deserializer DES and a serializer SER may be implemented in the CSI host 1612 and the CSI device 1641, respectively.

A display serial interface (DSI) host 1611 implemented in the application processor 1610 may perform serial communication with a DSI device 1651 included in the display 1650 through DSI.

At this time, an optical serializer SER and an optical deserializer DES may be implemented in the DSI host 1611 and the DSI device 1651, respectively.

The image processing system 1600 may also include a radio frequency (RF) chip 1660 communicating with the application processor 1610. A physical layer (PHY) 1613 of the application processor 1610 and a PHY 1661 of the RF chip 1660 may communicate data with each other according to MIPI DigRF.

The image processing system 1600 may further include a global positioning system (GPS) 1620, a storage 1670, a microphone (MIC) 1680, a dynamic random access memory (DRAM) 1685, and a speaker 1690.

The image processing system 1600 may communicate using a worldwide interoperability for microwave access (Wimax) 1691, a wireless local area network (WLAN) 1693, and/or an ultra-wideband (UWB) 1695.

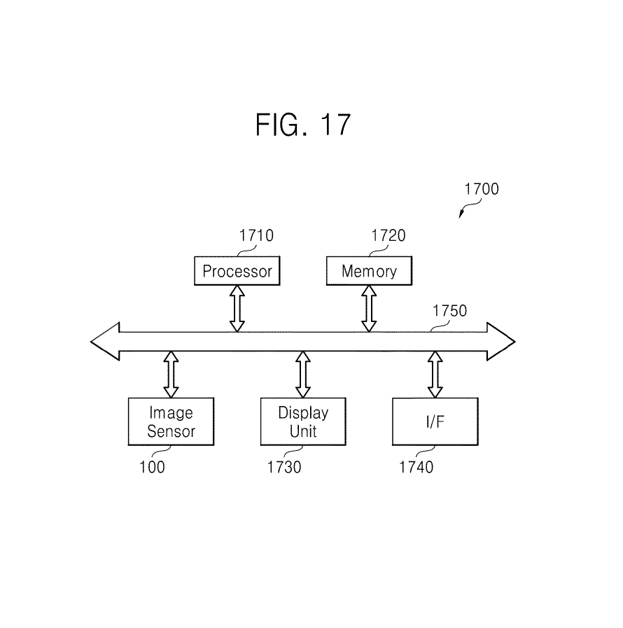

FIG. 17 is a block diagram of an image processing system 1700 including the image sensor 100 illustrated in FIG. 1 according to example embodiments of inventive concepts.

Referring to FIGS. 1 and 17, the image processing system 1700 may include the image sensor 100, a processor 1710, a memory 1720, a display unit 1730, and an I/F 1740.

The processor 1710 may control the operation of the image sensor 100. For instance, the processor 1710 may generate image data by processing pixel signals from the image sensor 100. The memory 1720 may store a program for controlling the operation of the image sensor 100 and image data generated by the processor 1710. The processor 1710 may execute the program stored in the memory 1720. The memory 1720 may be implemented by a volatile or non-volatile memory.

The display unit 1730 may display the image data output from the processor 1710 or the memory 1720. The display unit 1730 may be a liquid crystal display (LCD), a light emitting diode (LED) display, an organic LED (OLED) display, an active matrix OLED (AMOLED) display, or a flexible display.

The I/F 1740 may be implemented to input and output image data. The I/F 1740 may be a wireless I/F.

As described above, according to some example embodiments of inventive concepts, an image sensor senses signals output from pixels having a single transistor structure using a switch circuit in a sensing method.

While inventive conceptshave been particularly shown and described with reference to example embodiments thereof, it will be understood by those of ordinary skill in the art that various changes in forms and details may be made therein without departing from the spirit and scope of inventive concepts as defined by the following claims.

What is claimed is:

1. A sensing method for an image sensor including a plurality of pixels, each of the plurality of pixels being connected to one of a plurality of row lines and one of a plurality of column lines, the sensing method comprising:
connecting a first of the plurality of column lines with a second of the plurality of column lines in response to switch signals; and
sensing a first pixel signal generated based on a first signal output from a first pixel and a second signal output from a second pixel, the first pixel being connected to the first column line and the second pixel being connected to the second column line.

2. The sensing method of claim 1, further comprising:
applying a first voltage signal to the plurality of row lines to integrate photoelectrons in all remaining pixels excluding pixels connected to the first and second column lines.

3. The sensing method of claim 2, wherein the pixels connected to the first column line or the second column line are shielded by a metal.

4. The sensing method of claim 1, further comprising:
applying a first column voltage signal to the first column line to generate the first signal;
and
applying a second column voltage signal to the second column line to generate the second signal; wherein
the first column voltage signal and the second column voltage signal have different voltage levels.

5. The sensing method of claim 4, further comprising:
applying a first voltage signal to a row line connected to the first pixel and the second pixel to output the first signal and the second signal.

6. The sensing method of claim 1, wherein a third of the plurality of column lines is adjacent to one of the first and second column lines, and the method further includes,
disconnecting the first column line from the second column line,
connecting the third column line with the one of the first and second column lines; and
sensing a second pixel signal generated based on the second signal and a third signal output from a third pixel connected to the third column line.

7. The sensing method of claim 6, wherein the first pixel signal and the second pixel signal are sensed sequentially.

8. A sensing method for an image sensor including a plurality of odd-numbered pixels and a plurality of even-numbered pixels, each of the plurality of odd-numbered pixels being connected to one of a plurality of first row lines and one of a plurality of odd-numbered column lines, and each of the plurality of even-numbered pixels being connected to one of a plurality of second row lines and one of a plurality of even-numbered column lines, the sensing method comprising:
connecting each odd-numbered column line with a corresponding even-numbered column line in response to switch signals; and
sensing, for each pair of connected odd-numbered column line and corresponding even-numbered column line, a pixel signal generated based on a first signal output from a first pixel connected to the odd-numbered column line and a second signal output from a second pixel connected to the corresponding even-numbered column line.

9. The sensing method of claim 8, further comprising:
applying a first voltage signal to the plurality of second row lines to integrate photoelectrons in the plurality of even-numbered pixels.

10. The sensing method of claim 9, further comprising:
applying a second voltage signal to the plurality of first row lines to prevent photoelectrons from being integrated in the plurality of odd-numbered pixels.

11. The sensing method of claim 8, wherein for each pair of connected odd-numbered column line and corresponding even-numbered column line the method further includes,
applying a first column voltage signal to the odd-numbered column line to generate the first signal, and
applying a second column voltage signal to the corresponding even-numbered column line to generate the second signal, wherein
the first column voltage signal and the second column voltage signal have different voltage levels.

12. The sensing method of claim 11, further comprising:
applying a first voltage signal to a row line connected with the first and second pixels to output the first signal and the second signal.

13. The sensing method of claim 8, wherein the pixel signals are sensed simultaneously.

14. A sensing method for an image sensor, the method comprising:
sensing, at a sensing circuit, a first pixel signal generated based on a first signal output from a first of a plurality of pixels via a first column line and a second signal output from a second of the plurality of pixels via a second column line, the first column line and the second column line being concurrently connected to the sensing circuit in response to respective first and second switch signals.

15. The method of claim 14, further comprising:
connecting the first column line with the second column line.

16. The method of claim 15, wherein a third column line is adjacent to one of the first and second column lines, the method further including,
disconnecting the first column line from the second column line,
connecting the third column line to the one of the first and second column lines, and
sensing a second pixel signal generated based on the second signal and a third signal output from a third pixel connected to the third column line.

17. The method of claim 14, further comprising:
applying a first column voltage signal to the first column line to generate the first signal; and
applying a second column voltage signal to the second column line to generate the second signal; wherein
the first column voltage signal and the second column voltage signal have different voltage levels.

18. The method of claim 14, wherein the first column line is an odd-numbered column line among a plurality of odd-numbered column lines and the second column line is an even-numbered column line among a plurality of even-numbered column lines.

19. The method of claim 18, wherein the plurality of pixels includes a plurality of odd-numbered pixels and a plurality of even-numbered pixels, each of the plurality of odd-numbered pixels being connected to one of the plurality of odd-numbered column lines, and each of the plurality of even-numbered pixels being connected to one of the plurality of even-numbered column lines, and wherein the first pixel is an odd-numbered pixel among the plurality of odd-numbered pixels and the second pixel is an even-numbered pixel among the plurality of even-numbered pixels, the method further including,
connecting each odd-numbered column line with a corresponding even-numbered column line, and
sensing, for each pair of connected odd-numbered column line and corresponding even-numbered column line, a pixel signal generated based on a first signal output from an odd-numbered pixel connected to the odd-numbered column line and a second signal output from an even-numbered pixel connected to the corresponding even-numbered column line.

20. The method of claim 19, wherein the pixel signals for each pair of connected odd-numbered column line and corresponding even-numbered column line are sensed simultaneously.
